(19) United States
(12) Patent Application Publication
(10) Pub. No.: US 2012/0287051 A1
(43) Pub. Date: Nov. 15, 2012

(54) KEYPAD

(75) Inventor: Atsushi TAKABU, Kanagawa (JP)

(73) Assignee: KABUSHIKI KAISYA LEBEN HANBAI, Kanagawa (JP)

(21) Appl. No.: 13/367,676

(22) Filed: Feb. 7, 2012

(30) Foreign Application Priority Data
May 13, 2011 (JP) 2011-002651

(51) Int. Cl. G06F 3/02

(52) U.S. Cl. 345/169

(57) ABSTRACT

A keypad that provides excellent operability even in a virtual keyboard on a touch panel. The keypad comprises a base body 11, which covers the touch panel, and key tops 12, which are formed at positions corresponding to sensing areas of the touch panel. Each of the key tops 12 is formed to get in contact with the sensing area corresponding to the key top in question by pushing of the key top.

### BACKGROUND OF THE INVENTION

The present invention relates to a keypad.

Presently, mobile computers with wireless LAN are blooming, and many portable devices are used. Among such devices, there is a tablet computer provided with a touch-sensitive liquid crystal display. A tablet computer is not mounted with a keyboard specially as its input unit, and a touch panel integrated with a display can be used to perform input operation. Such a touch panel, which can be operated by directly touching a screen with a finger or the like, has been used frequently in industrial fields such as a Point Of Sale System (POS) and an Automated Teller Machine (ATM) until now. Recently, however, a touch panel is used in a consumer device, and its operability is improved further by employing the “multi-touch” function that sells intuitive operation and allows a touch of two points on the panel at one time.

FIG. 5 shows an example of such a computer. A tablet computer 90 is general one of a plate shape, comprising a frame part 91 and a touch panel 92. The touch panel 92 comprises; a screen keyboard display area 92a as a virtual keyboard shown on the display; and a text display area 92b for displaying text consisting of letters, symbols, and the like (i.e. characters). The screen keyboard area 92a is a virtual keyboard showing a key arrangement (for example, the QWERTY arrangement) of an ordinary keyboard, and here comprises a plurality of character display areas 92c corresponding to keys respectively. Each character display area is a sensing area that senses contact of or pressing by a fingertip or a pen point. When such contact or pressing is sensed, a character assigned to the display area in question is displayed in the text display area 92b.

As such a touch panel, there are various types of touch panels such as: a resistance film type, which responds to pressure by a pen, a finger, or the like; a capacitance type, which senses a change in the capacitance between a fingertip and a conductive film; an electromagnetic induction type, which utilize electromagnetic induction caused by bringing a pen closer; and a built-in optical sensor type, which optically recognizes a movement of a fingertip or a pen. In the types allowing use of a finger tip among these types, i.e. in the resistance film type, the capacitance type and the built-in optical sensor type, a user can use a screen keyboard as illustrated in FIG. 5 in the same finger position as that in an ordinary keyboard.

However, as for character input operation, the operability of such a screen keyboard does not come up to an ordinary keyboard yet. This is because the display of a plate shape makes it difficult to input relying on feeling in fingertips. This causes, for example, input failure owing to touching at an inappropriate part in touch-typing or difficulty in confirming the home position. Accordingly, it is difficult to input without an error unless by visual touching or single-finger touching.

On the other hand, the below-mentioned Patent Document 1 discloses a mobile keyboard. This, however, spoils portability of a mobile computer.
Patent Document 1; Japanese Unexamined Patent Application Laid-Open No. 2002-73256

Thus, an object of the present invention is to provide a keypad that gives a superior operational feeling even for a two-handed virtual keyboard on a touch panel.

### SUMMARY OF THE INVENTION

To solve the above problems, the present invention provides a keypad comprising a base body 11, which covers a touch panel, and key tops 12, which are formed at positions corresponding to sensing areas of the touch panel. Each of the key tops 12 is formed to get in contact with the sensing area corresponding to the key top in question by pushing of the key top.

According to the present invention, it is possible to provide a keypad that gives excellent operability even in a virtual keyboard on a touch panel.

### BRIEF DESCRIPTION OF THE DRAWINGS

FIG. 1 is an explanatory view showing a keypad 1 according to a first embodiment of the present invention;

FIG. 2 shows 2(a) a traverse cross-section view of the keypad 1 of the first embodiment of the present invention; and 2(b) a perspective view of the keypad 1 of the first embodiment of the present invention;

FIG. 3 is a cross-section view of the keypad 1 of the first embodiment of the present invention;

FIG. 4 shows 4(a) a cross-section view of a key top 121 used in a keypad of a modification 1 according to the present invention; 4(b) a cross-section view of a key top 122 used in a keypad of a modification 2 according to the present invention; and 4(c) a cross-section view of a key top 123 used in a keypad of a modification 3 according to the present invention; and

FIG. 5 is an explanatory view showing a conventional tablet computer 90.

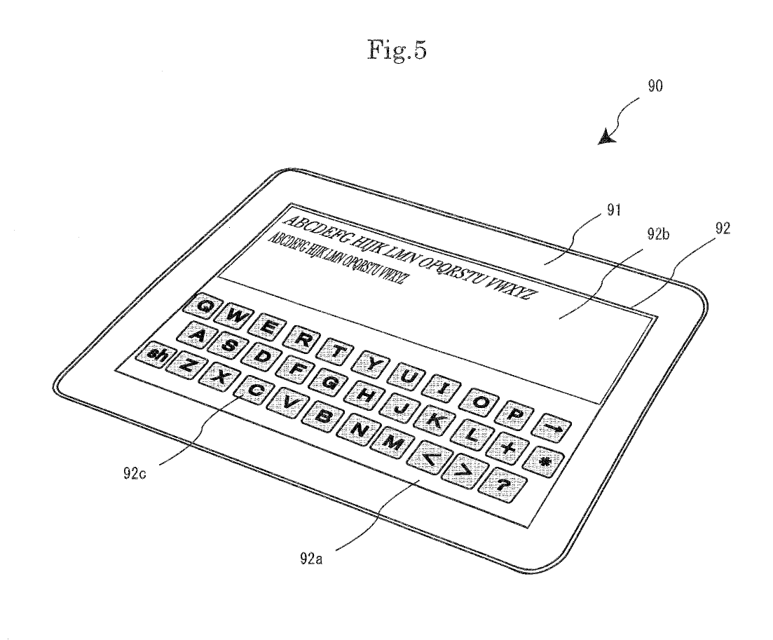

### DETAILED DESCRIPTION

Now, embodiments of the present invention will be described referring to the drawings.

### First Embodiment

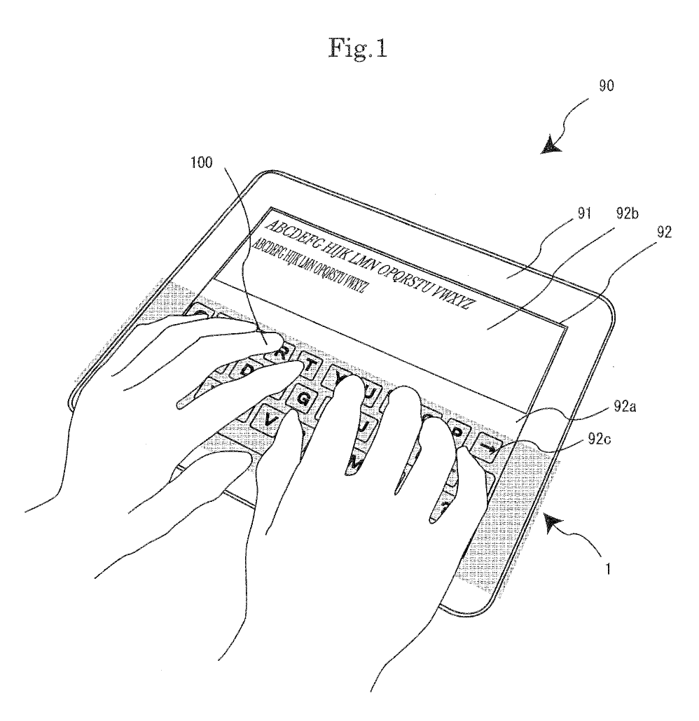

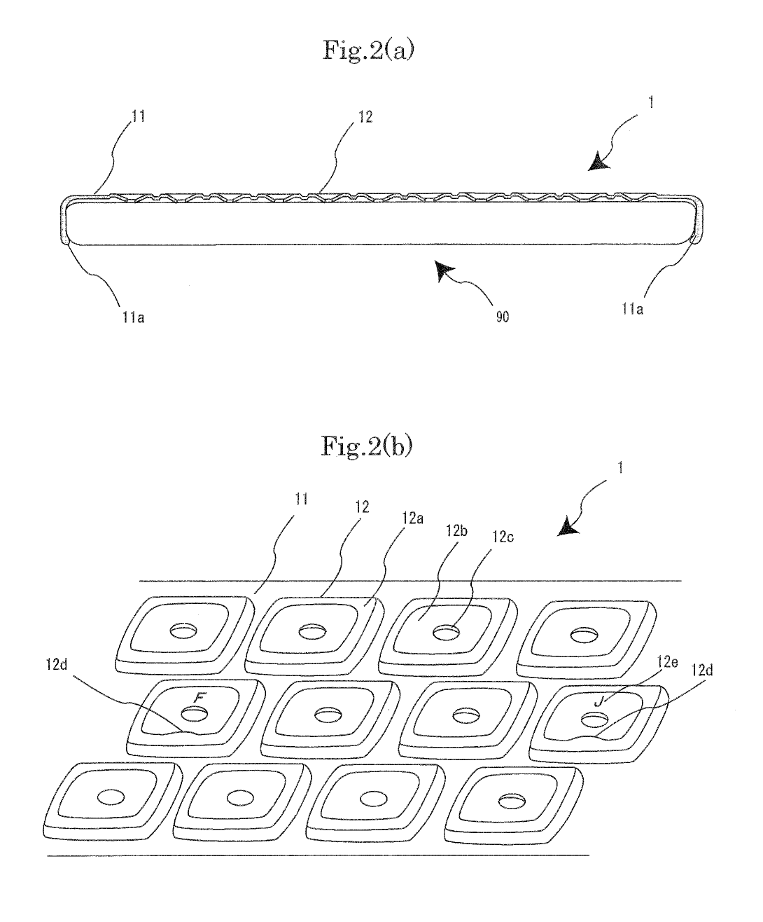

FIG. 1 is an explanatory view showing a keypad 1 according to a first embodiment of the present invention. FIG. 2(a) is a traverse cross-section view of the keypad 1 of the first embodiment of the present invention. And, FIG. 2(b) is a perspective view of the keypad 1 of the first embodiment of the present invention.

As shown in FIG. 1 and FIGS. 2(a) and 2(b), the keypad 1 as an embodiment of the present invention comprises: a base body 11 of a plate shape; and key tops 12 formed respectively to be positioned over and to correspond to character display areas (sensing areas) 92c.

The keypad 1 is used in a state that the keypad 1 is detachably overlaid upon a virtual keyboard displayed on a touch panel 92 of an ordinary tablet computer 90. Here, it is intended that the keypad 1 covers a screen keyboard display area 92a and side surfaces of the tablet computer 90.

The keypad 1 of this arrangement can be obtained by molding of an elastic material. As an elastic material, may be mentioned, for example, polymer such as rubber, silicone, polyethylene, polyurethane, and elastomer. By using such a material, it is possible to mold a thin and flexible keypad 1 so that the keypad 1 is deformed by pressing with a user's finger and the original form is restored by releasing the pressure.

As shown in FIG. 2(a), the base body 11 has tabs 11a at both ends. By fixing the tabs 11a on the side and back surfaces of the tablet computer 90, the keypad 1 can be fitted well on the tablet computer 90. The invention is not limited to this arrangement. It is possible to use a keypad that is wound on the tablet computer. Or, a keypad may be fixed by means of a band, or by using or providing suction cups.

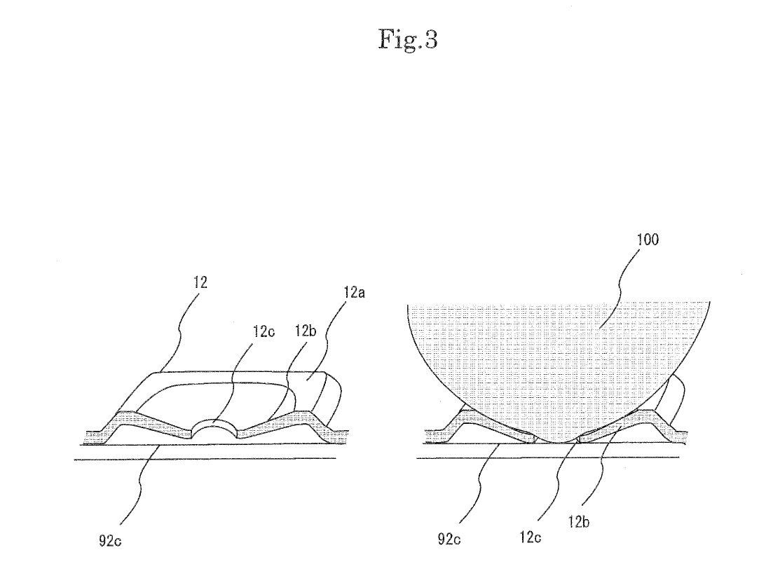

As shown in FIG. 2(b), each key top 12 has: a hollow edge portion 12a that is formed to rise from the base body 11; a concave portion 12b that is formed within the edge portion and recessed into a dome shape; and a through hole 12c that is formed roughly in the center of the concave portion. Here, the edge portion 12a is formed to be nearly equal in size to a character display area 92c. Further, here the key top 12 is held in a state of floating from the character display area 92c to avoid contact with the sensing area (See FIG. 3). Here, a sponge material may be used on the base body 11 at the portion corresponding to the periphery of each character display area 92c, or on the contrary may be used in wide contact with each character display area 92c, so as to avoid false operation caused by an unintended touch or by the weight of the keypad itself. Further, although not shown, it is possible to augment the feeling of the keys by employing a structure that emits a sound due to shape change when a key top 12 changes its shape by depression of the key top 12.

Here, the layout of the key tops 12 is of a three-line configuration conforming to the QWERTY layout, i.e. the layout of an ordinary keyboard. However, any layout may be employed. Further, the key tops 12 may have marks 12d such as projections to indicate the home position. Further, the key tops 12 or the keypad 1 itself may be formed to be transparent or semitransparent so that a user can see characters corresponding respectively to the keys. Of course it is possible to arrange that a character displayed in a character display area 92c can be seen through the through hole 12c. Or, a character 12e may be displayed for example by printing on each key top 12. In particular, when the keypad 1 is used at a dark place, it is favorable that the keypad 1 or at least the key tops 12 have translucency.

Hereinafter, specific usage of the above-described keypad 1 will be described. FIG. 3 is a cross-section of the keypad 1 of the first embodiment of the present invention.

As shown in FIG. 3, a user puts his fingertip 100 in the dome-shaped concave portion 12b of a key top 12 positioned over the character display area 92c of any character that the user wants to input, and pushes the concave portion 12b. Then, the key top 12 is deformed, being bent downward (toward the touch panel). In the case where the touch panel 92 is of the capacitance type, contact of the user's fingertip 100 with the character display area 92c through the through hole 12c is detected, and the character assigned to the character display area 92c is displayed in the text display area 92b. On the other hand, in the case where the touch panel 92 is of the resistance film type, pressuring of the character display area 92c by the bottom of the key top 12 or the user's fingertip 100 is detected, and the character assigned to the character display area 92c is displayed in the text display area 92b. When the finger is disengaged from the key top 12, then the key top 12 returns to the original shape. Of course, it is possible to operate a touch panel of another type such as the built-in optical sensor type.

According to the thus-described shape of key top 12, a user's finger is naturally led onto the through hole 12c opened over the character display area 92c corresponding to the character that the user wants to input, and thus the user can perform input operation (touching) at a right point. Accordingly, it is possible to reduce false operation significantly. Further, the location of each key top 12 (or a character display area 92c) can be found through a touch of a fingertip, and therefore touch-typing can be carried out easily too. Further, it is possible to get proper feeling of typing, and thus a good operational feeling and pleasantness are obtained.

Hereinabove, one embodiment of keypad according to the present invention has been described. The above-described keypad is not restrictive, and many alternatives, modifications and variations are obvious to those skilled in the art. In the following, such variations will be described.

### [Variation 1]

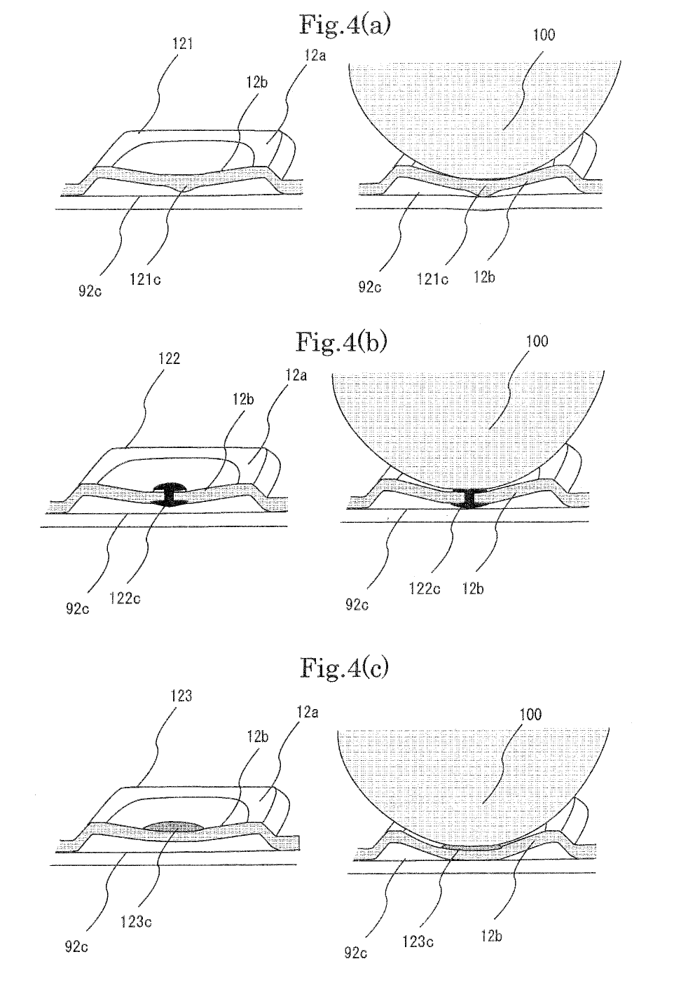

FIG. 4(a) is a cross-section of a key top 121 formed in a keypad of a variation 1 according to the present invention. In the following description of variations, the same symbols are used to indicate the same components as those in the above embodiment, and thus their detailed description will be omitted.

Although the key top 121 of this variation has the almost same configuration as that of the key top 12 of the first embodiment, this key top 121 is different from the key top 12 of the first embodiment in that this key top 121 has a convex portion 121c toward the touch panel instead of the through hole 12c. When, in the key top 121 of this arrangement, a user pushes the concave portion 12b, the convex portion 121c presses the character display area 92c. By detecting this pressuring, input operation is fulfilled. This arrangement is particularly suitable for the case of the resistance film type.

### [Variation 2]

FIG. 4(b) is a cross-section of a key top 122 formed in a keypad of a variation 2 according to the present invention.

Although the key top 122 of this variation has the almost same configuration as that of the key top 121 of the variation 1, this key top 122 is different from the key top 121 of the variation 1 in that this key top 122 has a convex portion 122c of a conductive material instead of the convex portion 121c of the variation 1. When, in the key top 122 of this arrangement, a user pushes the concave portion 12b, the convex portion 122c contacts with the character display area 92c. By detecting this touch, input operation is fulfilled. This arrangement is suitable for both the capacitance type and the resistance film type of touch panels 92. The convex portion 122c may be formed of a hard material so that a hit sound due to a hit is emitted when the convex portion 122c contacts with the character display area 92c. Even if the whole convex portion 122c is not formed of a conductive material, it is sufficient that the surface is coated with a conductive coating material, or includes such material, or is partly attached with such material so that a fingertip 100 connects electrically with the sensing area.

### [Variation 3]

FIG. 4(c) is a cross-section of a key top 123 formed in a keypad of a variation 3 according to the present invention.

Although the key top 123 of this variation has the almost same configuration as that of the key top 121 of the variation 1, this key top 123 is different from the key top 121 of the variation 1 in that this key top 123 has a convex portion 123c having a reflecting surface instead of the convex portion 121c of the variation 1. The key top 123 of this arrangement is particularly suitable for the built-in optical sensor type that has optical sensors embedded in a transistor-shaped surface of a liquid crystal panel. More specifically, when a user pushes the concave portion 12b, the convex portion 123c contacts with the character display area 92c. By detecting the reflection or shadow of the contact portion, input operation is fulfilled. This reflecting surface can be formed by attaching a reflecting member adapted for an optical sensor, or by painting or printing. Further, the material of the key top 123 may be a transparent material so that it is hard for an optical sensor to sense the key top 123. Or, to prevent surface reflection, the surface of the key top 123 may be subjected to, for example, grain or hair line finishing in order to scatter or absorb light. Further, judgment of a push of a key is performed by software installed on the tablet computer on the basis of the sensing level of an optical sensor. The threshold of sensing level may be adjusted when the keypad is used. The threshold should be set such that a push of a key top is judged to be a push of a key.

Thus, the keypad 1 of the present invention can be adapted for various types of sensing techniques. Of course, the touch panel is not limited to the above-described one, and the keypad 1 of the present invention can be applied to any touch panel whose input operation can be performed by contact of a finger or an object. Further, it is possible to use a combination of the characteristics of the above-described embodiments and variations.

It is not necessary to form a through hole or a convex portion in the key top. In the case of the resistance film type, input operation can be performed sufficiently only if the bottom of the concave portion 12b presses the character display area 92c.

Further, regardless of the type of virtual screen keyboard, the keypad 1 of the present invention can be easily adapted to any virtual screen keyboard by replacing with the corresponding keypad 1.

It is further possible to make each sensing area on the touch panel side smaller so that pressing through the through hole or by the convex portion can be detected with pinpoint accuracy. This can reduce false operation furthermore. Further, it is possible to arrange that the keypad 1 covers also the other area than the character display area in order to protect the whole surface of the display area.

1: keypad, 11: base body, 11a: tab, 12, 121, 122 and 123: key tops, 12a: edge portion, 12b: concave portion, 12c: through hole, 12d: marks, 12e: character, 121c, 122c and 123c: convex portions, 90: tablet computer, 91: frame part, 92: touch panel, 92a: screen keyboard display area, 92b: text display area, 92c: character display area, 100: fingertip

1. A two-handed keypad, wherein:
the keypad comprises:
a base body, which covers a touch panel of a tablet computer; and
key tops, which are formed at positions corresponding to sensing areas of the touch panel;
a part or all of the key tops are of QWERTY layout; and
each key top is formed to have: an edge portion rising from the base body; a concave portion, which is recessed within the edge or dents by pushing; and a through hole, which is formed at a center of the concave portion.

2. A two-handed keypad, wherein:
the key pad comprises:
a base body, which covers a touch panel of a tablet computer; and
key tops, which are formed at positions corresponding to sensing areas of the touch panel;
a part or all of the key tops are of QWERTY layout;
each key top is formed to have: an edge portion rising from the base body; a concave portion, which is recessed within the edge or dents by pushing; and a contact point portion, which is formed at a center of the concave portion; and
the contact point portion is formed to comprise a conductive member and to get in contact with the sensing area corresponding to the key top in question by pushing of the key top, so as to be realized dielectric sensing by the sensing area.

3. A two-handed keypad, wherein:
the keypad comprises:
a base body, which covers a touch panel of a tablet computer; and
key tops, which are formed at positions corresponding to sensing areas of the touch panel;
a part or all of the key tops are of QWERTY layout;
each key top is formed to have: an edge portion rising from the base body; a concave portion, which is recessed within the edge or dents by pushing; and a reflecting point portion, which is formed at a center of the concave portion; and
the reflecting point portion is formed to comprise a light reflective member and to reflect the light from the sensing area corresponding to the key top in question when the key top is pushed, so as to be sensed light reflection by the sensing area.

4. A two-handed keypad of claim 1, wherein:
the key tops are formed with positioning projections for determining a home position.
